(19) United States
(12) Patent Application Publication
(10) Pub. No.: US 2023/0295358 A1
(43) Pub. Date: Sep. 21, 2023

(54) GLUTARIMIDE RESIN

(71) Applicant: KANEKA CORPORATION, Osaka (JP)

(72) Inventors: Tomoki Hiiro, Osaka (JP); Riru Nishikawa, Osaka (JP); Keita Hirai, Osaka (JP); Keisuke Hatano, Osaka (JP)

(73) Assignee: KANEKA CORPORATION, Osaka (JP)

(21) Appl. No.: 18/324,447

(22) Filed: May 26, 2023

Related U.S. Application Data
(63) Continuation of application No. PCT/JP2021/043686, filed on Nov. 29, 2021.

(30) Foreign Application Priority Data
Nov. 27, 2020 (JP) 2020-197427

(51) Int. Cl. C08F 220/14; G02B 1/08

(52) U.S. Cl. CPC C08F 220/14; G02B 1/08

(57) ABSTRACT

A glutarimide resin contains repeating units of formula (1), wherein R¹ and R² are each independently hydrogen or an alkyl group having 1 to 8 carbon atoms; repeating units of formula (2), wherein R³ and R⁴ are each independently hydrogen or an alkyl group having 1 to 8 carbon atoms, and repeating units of formula (3), wherein R⁵ and R⁶ are each independently hydrogen or an alkyl group having 1 to 8 carbon atoms, and R⁷ is an alkyl group having 1 to 18 carbon atoms, a cycloalkyl group having 3 to 12 carbon atoms, or a substituent containing an aromatic ring having 5 to 15 carbon atoms. The glutarimide resin satisfies the following inequality: 3≤M1+M2≤20. M1 is the content (mol %) of the repeating units of the formula (1) and M2 is the content (mol %) of the repeating units of the formula (2).

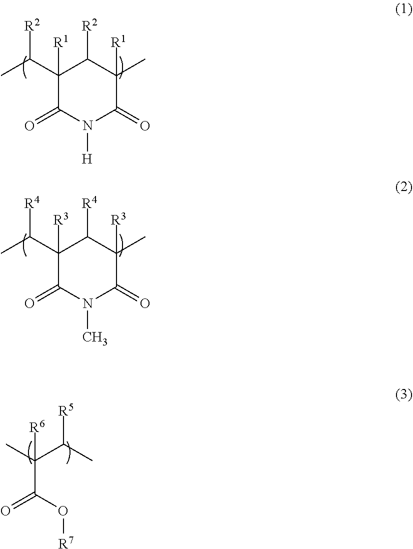

### TECHNICAL FIELD

One or more embodiments of the present invention relate to a glutarimide resin, a method for producing the resin, and a film and substrate that are made with the resin.

### BACKGROUND

Liquid crystal display devices are equipped with various films such as a polarizing film to ensure the quality of displayed images. For the purpose of further reducing the weight of liquid crystal display devices for portable information terminals or mobile phones, plastic liquid crystal display devices employing a resin film instead of a glass substrate have been put into practice.

A known example of resins forming optical films usable in such liquid crystal display devices is a (meth)acrylic resin containing glutarimide units (see Patent Literatures 1 and 2, for example).

### PATENT LITERATURE

PTL 1: Japanese Laid-Open Patent Application Publication No. 2010-261025
PTL 2: Japanese Laid-Open Patent Application Publication No. 2008-255175

For films such as polarizer protective films of liquid crystal display devices, it is required that the retardation expressed as the birefringence multiplied by the thickness be small. In some cases, the films are required to be resistant to a change in retardation induced by causes such as an external stress.

Patent Literature 1 describes a resin having a glutarimide structure and used for a polarizer protective film, and mentions methylamine as an exemplary modifying agent. In the case of using methylamine for modification and attempting to achieve an orientation birefringence that is sufficiently small for practical use, there is room for improvement in terms of the balance between orientation birefringence and heat resistance.

Patent Literature 2 discloses a glutarimide resin obtained by copolymerization of methyl methacrylate and methacrylamide and subsequent cyclization of the copolymer. In the case of this glutarimide resin, it is difficult to ensure both sufficient heat resistance and an orientation birefringence that is sufficiently small for practical use.

In view of the above circumstances, one or more embodiments of the present invention aims to provide a glutarimide resin excellent in heat resistance and having a small orientation birefringence.

### SUMMARY

As a result of intensive studies, the present inventors have found that modification of a raw material resin such as poly(methyl methacrylate) with ammonia can yield a glutarimide resin with sufficient heat resistance while ensuring an orientation birefringence that is sufficiently small for practical use.

The present inventors have further found that the modification with ammonia allows for simultaneous introduction of two types of glutarimide ring structures into the resulting glutarimide resin and that the resulting glutarimide resin is excellent not only in the balance between orientation birefringence and heat resistance but also in handleability during a production process.

Specifically, one or more embodiments of the present invention relate to a glutarimide resin containing:
repeating units represented by the following formula (1):

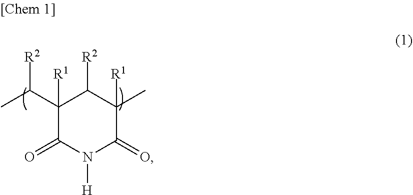

wherein R¹ and R² are each independently hydrogen or an alkyl group having 1 to 8 carbon atoms;
repeating units represented by the following formula (2):

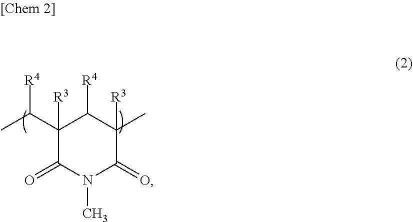

wherein R³ and R⁴ are each independently hydrogen or an alkyl group having 1 to 8 carbon atoms; and
repeating units represented by the following formula (3):

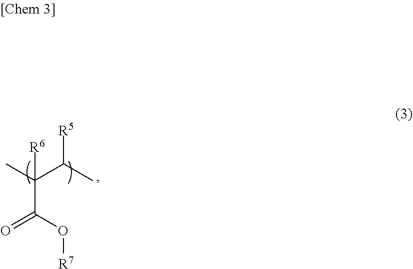

wherein R⁵ and R⁶ are each independently hydrogen or an alkyl group having 1 to 8 carbon atoms, and R⁷ is an alkyl group having 1 to 18 carbon atoms, a cycloalkyl group having 3 to 12 carbon atoms, or a substituent containing an aromatic ring having 5 to 15 carbon atoms, wherein
the glutarimide resin satisfies the following inequality (a):
3≤M1+M2≤20 (a), wherein M1 is a content (mol %) of the repeating units represented by the formula (1) in the glutarimide resin, M2 is a content (mol %) of the repeating units represented by the formula (2) in the glutarimide resin, M1>0, and M2>0.

A glass transition temperature of the glutarimide resin may be 120° C. or higher.

A 5% weight loss temperature in TGA measurement of the glutarimide resin may be 350° C. or higher.

An orientation birefringence of the glutarimide resin may be from −0.01×10⁻³ to 2.0×10⁻³.

One or more embodiments of the present invention also relate to a glutarimide resin composition containing the glutarimide resin.

One or more embodiments of the present invention further relate to an optical film containing the glutarimide resin composition.

Preferably, an in-plane retardation Re of the optical film at a wavelength of 590 nm is 10 nm or less, and an absolute value of an out-of-plane retardation Rth of the optical film at a wavelength of 590 nm is 40 nm or less.

One or more embodiments of the present invention may be a polarizer protective film including the optical film.

One or more embodiments of the present invention may be a substrate containing the glutarimide resin composition.

One or more embodiments of the present invention further relate to a method for producing a glutarimide resin, the method including reacting a raw material resin with ammonia, wherein the raw material resin has a content of acrylic ester monomer units of less than 1 wt % and contains repeating units represented by the formula (3).

One or more embodiments of the present invention can provide a glutarimide resin excellent in heat resistance and having a small orientation birefringence. One or more embodiments of the present invention can further provide a simple production method capable of simultaneous introduction of two types of glutarimide ring structures.

Additionally, the glutarimide resin according to one or more embodiments of the present invention has high heat resistance even when produced using a reduced amount of imidization agent. This allows for a decrease in reaction time during the imidization step, leading to improved productivity. Another advantage is that the amount of gas emission during the imidization step can be reduced.

### DETAILED DESCRIPTION

(Glutarimide Resin)

A glutarimide resin according to the present disclosure contains:
repeating units represented by the following formula (1):

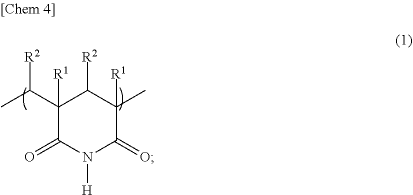

repeating units represented by the following formula (2):

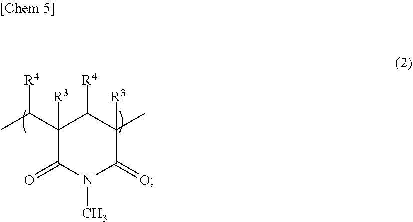

and
repeating units represented by the following formula (3):

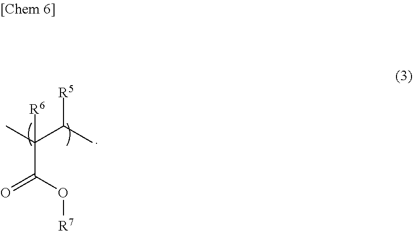

In the formula (1), R¹ and R² are each independently hydrogen or an alkyl group having 1 to 8 carbon atoms. A methyl group is preferred as R¹. A hydrogen atom is preferred as R².

In the formula (2), R³ and R⁴ are each independently hydrogen or an alkyl group having 1 to 8 carbon atoms. A methyl group is preferred as R³. A hydrogen atom is preferred as R⁴.

In the formula (3), R⁵ and R⁶ are each independently hydrogen or an alkyl group having 1 to 8 carbon atoms, and R⁷ is an alkyl group having 1 to 18 carbon atoms, a cycloalkyl group having 3 to 12 carbon atoms, or a substituent containing an aromatic ring having 5 to 15 carbon atoms. Hydrogen is preferred as R⁵. A methyl group is preferred as R⁶. A methyl group is preferred as R⁷.

Specifically, (meth)acrylate ester units can be used as the repeating units represented by the formula (3). Examples of the (meth)acrylate ester units include structures derived from methyl (meth)acrylate, ethyl (meth)acrylate, butyl (meth)acrylate, isobutyl (meth)acrylate, t-butyl (meth)acrylate, benzyl (meth)acrylate, and cyclohexyl (meth)acrylate. Two or more different types of such structures may be contained as the repeating units.

Methyl methacrylate units are preferred in terms of good balance between heat resistance and orientation birefringence. The proportion of the methyl methacrylate units in the repeating units represented by the formula (3) may be from 50 to 100 mol %, from 70 to 100 mol %, from 80 to 100 mol %, or from 90 to 100 mol %.

The glutarimide resin according to the present disclosure satisfies the following inequality (a).

3≤M1+M2≤20 (a)

In the inequality, M1 is the content (mol %) of the repeating units represented by the formula (1) in the glutarimide resin, M2 is the content (mol %) of the repeating units represented by the formula (2) in the glutarimide resin, M1>0, and M2>0.

For the glutarimide resin according to the present disclosure, a larger value of M1+M2 is more preferred in terms of heat resistance. Specifically, the value of M1+M2 may be at least 3 mol %, 4 mol % or more, or 5 mol % or more. In terms of orientation birefringence, a smaller value of M1+M2 is more preferred. Specifically, the value of M1+M2 may be at most 20 mol %, 17 mol % or less, 15 mol % or less, 12 mol % or less, 10 mol % or less, or 8 mol % or less.

When the value of M1+M2 is in the range as mentioned above, the glutarimide resin can exhibit increased heat resistance while maintaining an orientation birefringence that is sufficiently small for practical use. If the value of M1+M2 is less than 3 mol %, the heat resistance could be insufficient. If the value of M1+M2 is more than 20 mol %, the orientation birefringence increases, and this could be unfavorable for some purposes.

The glutarimide resin according to the present disclosure has high heat resistance even when the value of M1+M2 is relatively small. A large value of M1+M2 could lead to brittleness of a film made with the glutarimide resin. When the value of M1+M2 is in the range as mentioned above, a film made with the glutarimide resin can avoid being brittle.

Both the repeating units represented by the formula (1) and the repeating units represented by the formula (2) are responsible for the heat resistance and the orientation birefringence. The repeating units represented by the formula (1) are more responsible not only for the heat resistance but also for the orientation birefringence than the repeating units represented by the formula (2). That is, the fact that the repeating units represented by the formula (1) and the repeating units represented by the formula (2) are contained makes it possible to efficiently achieve both high heat resistance and a substantially small orientation birefringence. Additionally, the repeating units represented by the formula (2) are more effective in preventing the viscosity increase of the glutarimide resin than the repeating units represented by the formula (1). This allows for easy handling of the glutarimide resin in subsequent production steps.

Preferably, the glutarimide resin according to the present disclosure further satisfies the following inequality (b).

0.5≤M1/M2≤2.0 (b)

When the ratio M1/M2 is in this range, both high heat resistance and a small orientation birefringence can be achieved in a more balanced manner. 0.7≤M1/M2≤1.7 may be satisfied. 0.8≤M1/M2≤1.5 may be satisfied.

The respective values of M1 and M2 are not limited to particular ranges and may be in any ranges as long as the glutarimide resin satisfies the inequality (a) and preferably the inequality (b). The value of M1 may be 0.5 mol % or more, 1 mol % or more, or 1.2 mol % or more. The value of M2 may be 0.5 mol % or more, 1 mol % or more, or 1.2 mol % or more.

The values of M1 and M2 can be determined by obtaining an NMR chart through 1H-NMR spectroscopy, calculating the areas of the peaks attributed to the related structures in the chart, and finding the values of M1 and M2 based on the proportions of the calculated areas. The following is an example of how to determine the values of M1 and M2. An amount of 30 mg of the resin is dissolved in 0.75 ml of deuterated DMSO, and the dissolved resin is subjected to 1H-NMR spectroscopy using Avance NEO 700 (700 MHz), a 1H-NMR spectrometer manufactured by BRUKER. An area A of a peak observed at around 3.5 to 3.8 ppm and attributed to the O—CH₃ protons of methyl methacrylate is divided by 3 to give a value A′. An area B of a peak observed at around 3.0 to 3.3 ppm and attributed to the N—CH₃ protons of the formula (2) is divided by 3 to give a value B′. An area C of a peak observed at around 10.4 to 10.9 ppm and attributed to the N—H proton of the formula (1) is calculated. An area D of a peak observed at around 12.3 to 12.9 ppm and attributed to the COOH proton is calculated. The values of M1 and M2 can be determined by the following equations.

M1=C/(A′+B′+C+D)×100

M2=B′/(A′+B′+C+D)×100

The content M3 of the repeating units represented by the formula (3) in the glutarimide resin is not limited to a particular range and may be in any range as long as the glutarimide resin satisfies the inequality (a) and preferably the inequality (b). The content M3 may be from 70 to 97 mol %, from 75 to 96 mol %, and or from 80 to 95 mol %.

The value of M3 can be determined in the same manner as the values of M1 and M2. In the above example, the value of M3 can be determined by the following equation.

M3=A′/(A′+B′+C+D)×100

The glass transition temperature of the glutarimide resin may be 120° C. or higher, 125° C. or higher, 128° C. or higher, 130° C. or higher, or 135° C. or higher. The glass transition temperature can be determined as follows: 10 mg of the resin is analyzed using a differential scanning calorimeter (DSC; DSC-50 manufactured by Shimadzu Corporation) in a nitrogen atmosphere at a temperature rise rate of 20° C./min, and the glass transition temperature is calculated by a midpoint method.

The 5% weight loss temperature in TGA measurement of the glutarimide resin may be 350° C. or higher, 353° C. or higher, 355° C. or higher, 360° C. or higher, 365° C. or higher, or 369° C. or higher. The 5% weight loss temperature in TGA measurement can be determined as follows: 15 mg of the resin is analyzed using a thermogravimetric analyzer (TGA; STA 7200 manufactured by Hitachi High-Tech Science Corporation) in a nitrogen atmosphere with a temperature rise from room temperature at a rate of 10° C./min, and the temperature at which the weight loss on heating (wt %) of the resin reaches 5% is determined as the 5% weight loss temperature.

The orientation birefringence of the glutarimide resin according to the present disclosure may be from −0.01×10⁻³ to 2.0×10⁻³, 1.5×10⁻³ or less, 1.0×10⁻³ or less, 0.5×10⁻³ or less, or 0.25×10⁻³ or less. If the orientation birefringence is outside the above range, the glutarimide resin could have limited application.

Unless otherwise stated, the term “orientation birefringence” as used herein refers to a birefringence measured for a stretched film obtained by making a film with the glutarimide resin and stretching the film by 100% at a temperature 5° C. above the glass transition temperature of the resin. The orientation birefringence (Δn) is defined as Δn=nx−ny=Re/d and can be measured by means of a retardation meter.

The photoelastic coefficient of the glutarimide resin according to the present disclosure may be 20×10⁻¹² m²/N or less, 10×10⁻¹² m²/N or less, or 5×10⁻¹² m²/N or less.

If the absolute value of the photoelastic coefficient is greater than 20×10⁻¹² m²/N, light leakage tends to occur, and this tendency is especially evident in a hot, humid environment.

The photoelastic coefficient will be described. When an external force is applied to an isotropic solid to cause a stress (ΔF) in the solid, the solid temporarily has optical anisotropy and exhibits a birefringence (Δn). The ratio between the stress and the birefringence is called photoelastic coefficient c, which is expressed as follows.

c=Δn/ΔF

The photoelastic coefficient as described herein refers to that measured by Sénarmont method using a wavelength of 515 nm at 23° C. and 50% RH.

The acid value of a resin indicates the contents of carboxylic acid units and acid anhydride units in the resin. The acid value can be calculated, for example, by a titration method as described in WO 2005/054311.

The acid value of the glutarimide resin according to the present disclosure may be from 0.10 to 1.00 mmol/g. When the acid value is in this range, the glutarimide resin having a good balance of heat resistance, mechanical properties, and moldability can be obtained.

The content of carboxylic acid, which is one of the acid components, may be from 0.25 mmol/g or less or 0.20 mmol/g or less in terms of moldability.

The carboxylic acid content can be calculated using an acid value (DMSO acid value) measured by a titration method identical to that described in WO 2005/054311 except that dimethylsulfoxide is used as the solvent instead of methanol. Specifically, the carboxylic acid content can be calculated by the following equation.

(Carboxylic acid content)=2×(acid value)−(DMSO acid value)

In the titration method using methanol, one molecule of acid anhydride is counted as one molecule, while in the titration method using dimethylsulfoxide, one molecule of acid anhydride is counted as two molecules. This is why the above equation can be employed.

The content of acrylic ester units in the glutarimide resin according to the present disclosure may be less than 1 wt % or less, less than 0.5 wt %, or less than 0.3 wt % in terms of thermal stability. The lower limit of the content of acrylic ester units is not limited to a particular value. The content of acrylic ester units may be as small as possible, and it is more preferable that no acrylic ester units be contained.

In the case where a raw material resin is prepared by polymerizing monomers the types and proportions of which are adjusted and where the glutarimide resin is produced by cyclizing the raw material resin under heating, the acrylic ester content in the total starting monomers for preparing the raw material resin may be considered as the content of acrylic ester units in the glutarimide resin. It should be appreciated that the content of acrylic ester units in the glutarimide resin is 0% when any acrylic ester is not used as a monomer.

If necessary, the glutarimide resin may further contain copolymerized units other than the repeating units represented by the formulae (1) to (3), carboxylic acid units, and carboxylic anhydride units.

Examples of the other units include: units derived from aromatic vinyl monomers such as styrene; units derived from nitrile monomers such as acrylonitrile and methacrylonitrile; and units derived from maleimide monomers such as maleimide, N-methylmaleimide, N-phenylmaleimide, and N-cyclohexylmaleimide.

These other units may be copolymerized directly in the glutarimide resin or graft-copolymerized to the glutarimide resin.

The weight-average molecular weight of the glutarimide resin is not limited to a particular range, but may be from 1×10⁴ to 5×10⁵ or from 5×10⁴ to 3×10⁵. When the weight-average molecular weight is in this range, the glutarimide resin can have high moldability and exhibit high mechanical strength when processed into a film.

(Method for Producing Glutarimide Resin)

The glutarimide resin according to the present disclosure may be produced by reacting a raw material resin having repeating units represented by the formula (3) with ammonia. The raw material resin may be a polymer having a content of acrylic ester monomer units of less than 1 wt % and having repeating units represented by the formula (3). The raw material resin may be a poly(methyl methacrylate) resin or a poly(methyl methacrylate) resin having a content of acrylic ester monomer units of less than 1 wt %.

The content of the repeating units represented by the formula (3) in the raw material resin may be set as appropriate, but may be from 50 to 100 wt %, from 70 to 100 wt %, from 80 to 100 wt %, or from 90 to 100 wt %.

The method for producing the glutarimide resin according to the present disclosure is not limited to a particular technique. For example, a melt kneading process can be used which includes: a heating and melting step of melting a poly(methyl methacrylate) resin which is a preferred raw material resin; and an imidization step of treating the poly(methyl methacrylate) resin with an imidization agent. The following describes a glutarimide resin production method using the melt kneading process.

(a) Poly(Methyl Methacrylate) Resin

First, methyl methacrylate is polymerized to produce a poly(methyl methacrylate) resin.

The “poly(methyl methacrylate) resin” refers to a raw material resin in which the content of methyl methacrylate may be from 50 to 100 wt %. The content of methyl methacrylate may be from 70 to 100 wt %, from 80 to 100 wt %, or from 90 to 100 wt %.

In production of the poly(methyl methacrylate) resin, methyl methacrylate may be used in combination with another (meth)acrylate such as methyl acrylate, ethyl (meth)acrylate, butyl (meth)acrylate, isobutyl (meth)acrylate, t-butyl (meth)acrylate, benzyl (meth)acrylate, or cyclohexyl (meth)acrylate. In the case where methyl methacrylate is used in combination with another (meth)acrylate, the content of acrylic ester monomer units may be less than 1 wt %, less than 0.5 wt %, or less than 0.3 wt %.

In addition to the monomers described above, another monomer may be copolymerized, and examples of the other monomer include: aromatic monomers such as styrene and methylstyrene; nitrile monomers such as acrylonitrile and methacrylonitrile; and maleimide monomers such as maleimide, N-methylmaleimide, N-phenylmaleimide, and N-cyclohexylmaleimide.

The poly(methyl methacrylate) resin is not limited to a particular structure, and may be a linear polymer, a block polymer, a core-shell polymer, a branched polymer, a ladder polymer, or a crosslinked polymer. In the case where the poly(methyl methacrylate) resin is a block polymer, the block polymer may be of an A-B type, an A-B-C type, an A-B-A type, or any other type. In the case where the poly(methyl methacrylate) resin is a core-shell polymer, the core-shell structure may be composed of a single-layered core and a single-layered shell or composed of a multi-layered core and a multi-layered shell.

The method for producing the poly(methyl methacrylate) resin is not limited to a particular technique, and any of known polymerization processes such as emulsion polymerization, emulsion-suspension polymerization, suspension polymerization, bulk polymerization, and solution polymerization can be used. For use in the optical industry, bulk polymerization or solution polymerization is particularly preferred in terms of reducing the amount of impurities. For example, the poly(methyl methacrylate) resin can be produced according to a method as described in Japanese Laid-Open Patent Application Publication No. S56-8404, Japanese Examined Patent Application Publication No. H6-86492, Japanese Examined Patent Application Publication No. H7-37482, or Japanese Examined Patent Application Publication No. S52-32665.

(b) Imidization Step

The method for producing the glutarimide resin according to the present disclosure includes the step of heating and melting the poly(methyl methacrylate) resin and treating the poly(methyl methacrylate) resin with an imidization agent (imidization step). Thus, the glutarimide resin can be produced.

Ammonia is used as the imidization agent. The imidization using ammonia allows for introduction of both of the two types of glutarimide ring structures (units represented by the formula (1) and units represented by the formula (2)).

In the case of conventional imidization using methylamine, it is necessary to increase the imidization percentage to achieve improved heat resistance. Thus, the imidization step requires a lot of time, and the productivity tends to decrease. Additionally, an excessive increase in the imidization percentage could lead to brittleness of a film made with the glutarimide resin.

In contrast to the conventional imidization using methylamine, the imidization using ammonia allows the resulting glutarimide resin to have high heat resistance even when the imidization percentage (M1+M2) is low. Since the imidization percentage may be low, the reaction time in the imidization step can be reduced, and a film made with the glutarimide resin can avoid being brittle.

The ammonia used may be liquid ammonia or ammonia water. Since ammonia is compatible and efficiently reacts with the poly(methyl methacrylate) resin, the use of liquid ammonia is preferred in terms of productivity. Liquid ammonia has a higher concentration than ammonia water which is a water-diluted material, and the amount of liquid ammonia added for the reaction can be smaller than the amount of ammonia water required. The concentration of ammonia water is not limited to a particular range, but may be from about 25 to about 35 wt % in terms of availability and reactivity.

In the imidization step, the proportions of the repeating units represented by the formulae (1), (2), and (3) in the resulting glutarimide resin can be controlled by adjusting the proportion of the imidization agent added. Furthermore, by adjusting the degree of imidization, the physical properties of the resulting glutarimide resin and the optical and other properties of an optical film formed by molding of a composition containing the glutarimide resin can be controlled.

The amount of the imidization agent used can be adjusted as appropriate depending on the required properties and is, for example, 0.5 parts by weight or more per 100 parts by weight of the raw material resin. The amount of the imidization agent may be 0.6 parts by weight or more, 0.7 parts by weight or more, or 0.8 parts by weight or more. If the amount of the imidization agent is less than 0.5 parts by weight, the heat resistance of the resulting glutarimide resin composition could be reduced. The upper limit of the amount of the imidization agent can be chosen as appropriate in view of the balance between moldability and physical properties. In terms of ease of handling, the amount of the imidization agent may be 30 parts by weight or less, 20 parts by weight or less, 10 parts by weight or less, 5 parts by weight or less, 3 parts by weight or less, or 2 parts by weight or less. In the case where the imidization agent is ammonia water, the “amount of the imidization agent” refers to the amount of ammonia contained in the ammonia water used.

In the imidization step, a ring-closing accelerator (catalyst) may be added, if necessary, in addition to the imidization agent.

The method for performing the heating and melting and the treatment with the imidization agent is not limited to a particular technique, and any conventionally known technique can be used. For example, the poly(methyl methacrylate) resin can be imidized by a method using an extruder or a batch reaction vessel (pressure vessel).

In the case where the heating and melting and the treatment with the imidization agent are performed using an extruder, the extruder is not limited to a particular type, and any type of extruder can be used. Specifically, for example, a single-screw extruder, a twin-screw extruder, or a multi-screw extruder can be used.

In particular, it is preferable to use a twin-screw extruder. The use of a twin-screw extruder facilitates mixing of the imidization agent (or, in the case of using a ring-closing accelerator, mixing of the imidization agent and the ring-closing accelerator) with the poly(methyl methacrylate) resin.

Examples of the twin-screw extruder include a non-intermeshing corotating twin-screw extruder, an intermeshing corotating twin-screw extruder, a non-intermeshing counter-rotating twin-screw extruder, and an intermeshing counter-rotating twin-screw extruder. In particular, it is preferable to use an intermeshing corotating twin-screw extruder. A twin-screw extruder of the intermeshing corotating type is capable of high-speed rotation and can further facilitate mixing of the imidization agent (or, in the case of using a ring-closing accelerator, mixing of the imidization agent and the ring-closing accelerator) with the raw material resin.

One of the extruders mentioned above may be used alone, or two or more thereof may be connected in series and used in combination. For example, a tandem reaction extruder as described in Japanese Laid-Open Patent Application Publication No. 2008-273140 can be used.

When the imidization is performed in an extruder, for example, the poly(methyl methacrylate) resin is introduced through a raw material inlet of the extruder, the introduced resin is melted to fill the cylinder of the extruder with the resin, and then the imidization agent is injected into the extruder by means of a feed pump. In this manner, the imidization reaction can be induced in the extruder.

In this case, the temperature (resin temperature) of a reaction zone in the extruder may be from 180 to 300° C. or from 200 to 290° C. If the temperature (resin temperature) of the reaction zone is lower than 180° C., the imidization reaction hardly occurs, and the heat resistance tends to decrease. If the reaction zone temperature is higher than 300° C., the resin is decomposed significantly, and thus the folding endurance of a film formed from the resulting glutarimide resin tends to decrease. The “reaction zone” in the extruder refers to that region of the cylinder of the extruder which extends between the location of injection of the imidization agent and the resin discharge outlet (die part).

The degree of imidization can be increased by lengthening the reaction time in the reaction zone of the extruder. The reaction time in the reaction zone of the extruder may be more than 10 seconds or more than 30 seconds. If the reaction time is 10 seconds or less, the imidization could hardly occur.

The resin pressure in the extruder may be from atmospheric pressure to 50 MPa or from 1 to 30 MPa. If the resin pressure is less than 1 MPa, the imidization agent is poorly soluble, and the reaction tends to be retarded. If the resin pressure is more than 50 MPa, such a high pressure is above the maximum of the tolerable mechanical pressure of a normal extruder and necessitates the use of a special device, and this is not preferred in terms of cost.

In the case of using an extruder, the extruder may be equipped with a vent hole by which the pressure can be reduced to or below atmospheric pressure in order to remove the imidization agent remaining unreacted or by-products. With this configuration, the imidization agent remaining unreacted, by-products such as methanol, or monomers can be removed.

For the production of the glutarimide resin, a high viscosity-compatible reactor can be suitably used instead of an extruder, and examples of such a reactor include a horizontal twin-shaft reactor such as BIVOLAK manufactured by Sumitomo Heavy Industries, Ltd. and a vertical twin-shaft mixing vessel such as SUPERBLEND manufactured by Sumitomo Heavy Industries, Ltd.

In the case where the glutarimide resin is produced using a batch reaction vessel (pressure vessel), the batch reaction vessel (pressure vessel) is not limited to a particular structure.

Specifically, the batch reaction vessel may have any structure that can melt the poly(methyl methacrylate) resin by heating and stir the molten resin and that permits addition of the imidization agent (or, in the case of using a ring-closing accelerator, addition of the imidization agent and the ring-closing accelerator). Preferably, the batch reaction vessel has a structure that offers high stirring efficiency.

The use of such a batch reaction vessel (pressure vessel) can prevent insufficient stirring caused by a polymer viscosity increase accompanying the progress of the reaction. Examples of the batch reaction vessel (pressure vessel) having such a structure include MAXBLEND, a mixing vessel manufactured by Sumitomo Heavy Industries, Ltd.

Specific examples of the imidization method include known methods as described in Japanese Laid-Open Patent Application Publication No. 2008-273140 and Japanese Laid-Open Patent Application Publication No. 2008-274187.

The glutarimide resin according to the present disclosure may be further reacted with ammonia.

(c) Esterification Step

The method for producing the glutarimide resin according to the present disclosure may include the step of treating the resin with an esterification agent in addition to the imidization step described above. By the esterification step, the acid value of the glutarimide resin resulting from the imidization step can be adjusted to a desired range. Examples of the esterification agent include dimethyl carbonate, 2,2-dimethoxypropane, dimethylsulfoxide, triethyl orthoformate, trimethyl orthoacetate, trimethyl orthoformate, diphenyl carbonate, dimethyl sulfate, methyl toluenesulfonate, methyl trifluoromethylsulfonate, methyl acetate, methanol, ethanol, methyl isocyanate, p-chlorophenyl isocyanate, dimethylcarbodiimide, dimethyl-t-butylsilylchloride, isopropenyl acetate, dimethylurea, tetramethylammonium hydroxide, dimethyldiethoxysilane, tetra-N-butoxysilane, dimethyl (trimethylsilane) phosphite, trimethyl phosphite, trimethyl phosphate, tricresyl phosphate, diazomethane, ethylene oxide, propylene oxide, cyclohexene oxide, 2-ethylhexyl glycidyl ether, phenyl glycidyl ether, and benzyl glycidyl ether. Among these, dimethyl carbonate and trimethyl orthoacetate are preferred in terms of factors such as cost and reactivity. Dimethyl carbonate is preferred in terms of cost.

In the esterification step, the amount of the esterification agent used may be from 0 to 12 parts by weight or from 0 to 8 parts by weight per 100 parts by weight of the raw material resin.

When the amount of the esterification agent is in the above range, the acid value can be adjusted to a suitable range. If the amount of the esterification agent is outside the above range, the esterification agent could remain unreacted in the resin and cause bubble formation or odor emission when molding is performed using the resin.

A catalyst can also be used in addition to the esterification agent. The catalyst is not limited to a particular type, and examples of the catalyst include aliphatic tertiary amines such as trimethylamine, triethylamine, and tributylamine. Among these, triethylamine is preferred in terms of factors such as cost and reactivity.

In the esterification step, only heating treatment may be performed without using any esterification agent. In the case where only heating treatment (kneading and dispersing of the molten resin in an extruder) is performed, part or all of a carboxylic acid generated as a by-product in the imidization step and contained in the glutarimide resin can be converted into acid anhydride groups by a dehydration reaction between the carboxylic acid groups and/or a dealcoholization reaction between the carboxylic acid and alkyl ester groups. In this case, a ring-closing accelerator (catalyst) may be used. Also in the case of treating the resin with an esterification agent, the conversion of a carboxylic acid into acid anhydride groups may be induced by heating treatment.

(d) Devolatilization Step and Filtration Step

The glutarimide resin obtained through the imidization step and the optional esterification step contains the imidization agent remaining unreacted, the esterification agent remaining unreacted, and volatile components and resin decomposition products generated as by-products in the reactions. Thus, a vent hole by which the pressure can be reduced to or below atmospheric pressure may be located on the outlet side of the extruder.

A filter may be disposed at the end of the extruder to reduce the amount of foreign substances in the glutarimide resin. A gear pump may be disposed before the filter to increase the pressure of the glutarimide resin. As to the type of the filter, it is preferable to use a leaf disc filter made of stainless steel which can remove foreign substances from molten polymers. As to the filter element, it is preferable to use a fiber-type filter element, a powder-type filter element, or a filter element combining the fiber and powder types.

(Glutarimide Resin Composition)

The glutarimide resin according to the present disclosure can be blended with another resin or an additive as necessary to make a glutarimide resin composition. Examples of the additive include commonly-used additives such as: weather-resistant stabilizers such as an antioxidant, a thermal stabilizer, a light stabilizer, an ultraviolet absorber, and a radical scavenger; and other additives such as a catalyst, a plasticizer, a lubricant, an antistatic agent, a colorant, a shrinkage inhibitor, and an antibacterial/deodorizing agent. One of these additives may be added alone or two or more thereof may be added in combination without departing from the intent of one or more embodiments of the invention. These additives may be added in the below-described molding process of the glutarimide resin or the glutarimide resin composition.

The glutarimide resin composition according to the present disclosure may contain an ultraviolet absorber. The glutarimide resin according to the present disclosure is well compatible with ultraviolet absorbers, and the addition of an ultraviolet absorber can extend the range of applications of the glutarimide resin composition. Examples of the ultraviolet absorber include triazine compounds, benzotriazole compounds, benzophenone compounds, cyanoacrylate compounds, benzoxazine compounds, and oxadiazole compounds. Among these, triazine compounds are preferred in terms of the relationship of ultraviolet absorption performance versus added amount. The triazine compound used may be any commercially-available product.

The ultraviolet absorber may have a maximum absorption at a wavelength of 300 to 370 nm. When the glutarimide resin composition containing such an ultraviolet absorber is exposed to ultraviolet light, the ultraviolet absorber efficiently prevents degradation caused by ultraviolet A (having a wavelength of 320 to 400 nm). Thus, the amount of the ultraviolet absorber to be added can be relatively small, and bleed-out due to an increased amount of the ultraviolet absorber is not likely to occur.

For the ultraviolet absorber, the 1% weight loss temperature in a nitrogen atmosphere may be 350° C. or higher. Triazine compounds are preferred in terms of high heat resistance and high molar absorption coefficient. With the use of a triazine compound as the ultraviolet absorber, the amount of the ultraviolet absorber to be added can be reduced, and contamination of a mold (or a roll) during a molding process can be prevented. As described in Japanese Laid-Open Patent Application Publication No. 2014-95926, the use of an ultraviolet absorber made with a triazine compound can provide increased thermal stability without addition of any commonly-used thermal stabilizer.

Examples of the ultraviolet absorber made with a triazine compound include Tinuvin 1577, Tinuvin 460, Tinuvin 477, Tinuvin 479 (all of which are manufactured by BASF), and LA-F70 (manufactured by ADEKA Corporation).

In the case where the glutarimide resin composition according to the present disclosure contains an ultraviolet absorber, the amount of the ultraviolet absorber added may be from 0.1 to 5.0 parts by weight or from 0.4 to 2.0 parts by weight per 100 parts by weight of the glutarimide resin.

If the amount of the ultraviolet absorber is less than 0.1 parts by weight, the ultraviolet absorber could fail to exhibit a sufficient effect in applications requiring ultraviolet absorption performance. If the amount of the ultraviolet absorber is more than 2.0 parts by weight, the ultraviolet absorber could cause bleed-out in a film formed from the glutarimide resin composition.

In 27 g of the resulting glutarimide resin composition, the number of foreign substances having a size of 20 μm or more may be 30 or less, 20 or less, or 10 or less. The number of foreign substances having a size of 10 μm to less than 20 μm may be 300 or less, 200 or less, or 100 or less. The number of foreign substances having a size of 5 μm to less than 10 μm may be 1000 or less, 800 or less, or 500 or less.

The amount of foreign substances in the glutarimide resin composition is determined as follows. An amount of 10.0 to 10.5 g of the glutarimide resin composition is weighed out and dissolved in a liquid mixture of 230 to 245 g of methylene chloride and 15 g of Clynsolve to prepare a sample. Five such samples are prepared, and the number of foreign substances is counted for each sample. The total number of foreign substances in the five samples is defined herein as the amount of foreign substances in the glutarimide resin composition.

The measurement device used can be System 8011-100, an automatic liquid particle counting system manufactured by HIAC Royco (main counter: Model 8000 A Counter, sampler: Model ABS-2 Sampler, sensor: Model HRLD-100 Sensor).

(Other Components Contained in Glutarimide Resin Composition)

The glutarimide resin composition described above may contain a crosslinked elastic material in order to enhance the mechanical strength of the glutarimide resin. The crosslinked elastic material can be produced by a known polymerization process such as suspension polymerization, dispersion polymerization, emulsion polymerization, solution polymerization, or bulk polymerization. In particular, when producing a crosslinked elastic material as described below which has a core-shell structure, it is preferable to use a polymerization process such as suspension polymerization, dispersion polymerization, or emulsion polymerization.

The crosslinked elastic material may be a core-shell elastic material having a core layer made of a rubbery polymer and a shell layer made of a glassy polymer (rigid polymer). The core layer made of a rubbery polymer may have at least one layer made of a glassy polymer as an innermost layer or an intermediate layer.

The glass transition temperature Tg of the rubbery polymer constituting the core layer may be 20° C. or lower, from −60 to 20° C., or from −60 to 10° C. If the Tg of the rubbery polymer constituting the core layer is higher than 20° C., the enhancement of the mechanical strength of the glutarimide resin could be insufficient. The Tg of the glassy polymer (rigid polymer) constituting the shell layer may be 50° C. or higher, from 50 to 140° C., or from 60 to 130° C. If the Tg of the glassy polymer constituting the shell layer is lower than 50° C., the heat resistance of the glutarimide resin could be reduced.

The glass transition temperatures of the “rubbery polymer” and the “glassy polymer” are defined herein as those calculated by the Fox equation using values presented in Polymer Handbook (J. Brandrup, Interscience, 1989). For example, the glass transition temperature of poly(methyl methacrylate) is 105° C., and the glass transition temperature of poly(butyl acrylate) is −54° C.

The proportion of the core layer in the core-shell elastic material may be from 30 to 95 wt % or from 50 to 90 wt %. The proportion of the glassy polymer layer in the core layer may be from 0 to 60%, from 0 to 45%, or from 10 to 40% based on 100 wt % of the total amount of the core layer. The proportion of the shell layer in the core-shell elastic material may be from 5 to 70 wt % or from 10 to 50 wt %.

The core-shell elastic material may contain any other suitable components as long as the other components do not impair the effect of one or more embodiments of the invention.

The polymerizable monomer used to form the rubbery polymer constituting the core layer may be any suitable polymerizable monomer.

The polymerizable monomer for forming the rubbery polymer may contain an alkyl (meth)acrylate. The alkyl (meth)acrylate may be contained in an amount of 50 wt % or more, in an amount of 50 to 99.9 wt %, or in an amount of 60 to 99.9 wt % based on 100 wt % of the polymerizable monomer for forming the rubbery polymer.

Examples of the alkyl (meth)acrylate include alkyl (meth)acrylates whose alkyl group has 2 to 20 carbon atoms, such as ethyl (meth)acrylate, propyl (meth)acrylate, butyl (meth)acrylate, cyclohexyl (meth)acrylate, 2-ethylhexyl (meth)acrylate, isononyl (meth)acrylate, lauroyl (meth)acrylate, and stearyl (meth)acrylate. The alkyl group of the alkyl (meth)acrylate may have an alicyclic or aromatic cyclic substituent, a branched structure, or a functional group. Among the alkyl (meth)acrylates as mentioned above, butyl (meth)acrylate, 2-ethylhexyl (meth)acrylate, isononyl (meth)acrylate, benzyl (meth)acrylate, phenoxyethyl (meth)acrylate, and cyclohexyl (meth)acrylate are preferred, and butyl acrylate, 2-ethylhexyl acrylate, and isononyl acrylate are more preferred. One of the alkyl (meth)acrylates as mentioned above may be used alone, or two or more thereof may be used in combination.

The polymerizable monomer for forming the rubbery polymer may contain a polyfunctional monomer having two or more polymerizable functional groups in the molecule. In the polymerizable monomer for forming the rubbery polymer, the polyfunctional monomer having two or more polymerizable functional groups in the molecule may be contained in an amount of 0.01 to 20 wt %, in an amount of 0.1 to 20 wt %, in an amount of 0.1 to 10 wt %, or in an amount of from 0.2 to 5 wt %.

Examples of the polyfunctional monomer having two or more polymerizable functional groups in the molecule include: aromatic divinyl monomers such as divinylbenzene; alkane polyol poly(meth)acrylates such as ethylene glycol di(meth)acrylate, butylene glycol di(meth)acrylate, hexanediol di(meth)acrylate, oligoethylene glycol di(meth)acrylate, trimethylolpropane di(meth)acrylate, and trimethylolpropane tri(meth)acrylate; and other polyfunctional monomers such as urethane di(meth)acrylate, epoxy di(meth)acrylate, and triallyl isocyanurate. Examples of polyfunctional monomers having polymerizable functional groups differing in reactivity include allyl (meth)acrylate, diallyl maleate, diallyl fumarate, and diallyl itaconate. Among the polyfunctional monomers as mentioned above, ethylene glycol dimethacrylate, butylene glycol diacrylate, and allyl methacrylate are preferred. One of the polyfunctional monomers as mentioned above may be used alone, or two or more thereof may be used in combination.

The polymerizable monomer for forming the rubbery polymer may contain another polymerizable monomer polymerizable with the alkyl (meth)acrylate and the polyfunctional monomer having two or more polymerizable functional groups in the molecule. In the polymerizable monomer for forming the rubbery polymer, the other polymerizable monomer may be contained in an amount of 0 to 49.9 wt % or in an amount of 0 to 39.9 wt %.

Examples of the other polymerizable monomer include: aromatic vinyls such as styrene, vinyltoluene, and α-methylstyrene; aromatic vinylidenes; vinyl cyanides such as acrylonitrile and methacrylonitrile; vinylidene cyanides; and other polymerizable monomers such as methyl methacrylate, urethane acrylate, and urethane methacrylate.

The other polymerizable monomer may be a monomer having a functional group such as an epoxy group, a carboxyl group, a hydroxy group, or an amino group. Specific examples of the monomer having an epoxy group include glycidyl methacrylate. Specific examples of the monomer having a carboxyl group include methacrylic acid, acrylic acid, maleic acid, and itaconic acid. Specific examples of the monomer having a hydroxy group include 2-hydroxyethyl methacrylate and 2-hydroxyethyl acrylate. Specific examples of the monomer having an amino group include diethylaminoethyl methacrylate and diethylaminoethyl acrylate. One of the monomers as mentioned above may be used alone, or two or more thereof may be used in combination.

The polymerizable monomer for forming the rubbery polymer may be used in combination with a small amount of chain transfer agent. The chain transfer agent used may be any of a wide variety of known chain transfer agents. Examples of the chain transfer agent include: alkyl mercaptans such as octyl mercaptan, dodecyl mercaptan, and t-dodecyl mercaptan; and thioglycolic acid derivatives.

The polymerizable monomer used to form the glassy polymer constituting the shell layer or the glassy polymer layer of the core layer may be any suitable polymerizable monomer.

The polymerizable monomer for forming the glassy polymer may contain at least one monomer selected from an alkyl (meth)acrylate and an aromatic vinyl monomer. The at least one monomer selected from an alkyl (meth)acrylate and an aromatic vinyl monomer may be contained in an amount of 50 to 100 wt % or in an amount of 60 to 100 wt % based on 100 wt % of the polymerizable monomer for forming the glassy polymer.

The alkyl (meth)acrylate may be one whose alkyl group has 1 to 8 carbon atoms. The alkyl group may have an alicyclic or aromatic cyclic substituent, a branched structure, or a functional group. Examples of such an alkyl (meth)acrylate include methyl (meth)acrylate, ethyl (meth)acrylate, benzyl (meth)acrylate, cyclohexyl (meth)acrylate, butyl (meth)acrylate, and 2-ethylhexyl (meth)acrylate. Among these alkyl (meth)acrylates, methyl methacrylate is particularly preferred. One of these alkyl (meth)acrylates may be used alone, or two or more thereof may be used in combination.

Examples of the aromatic vinyl monomer include styrene, vinyltoluene, and α-methylstyrene, among which styrene is preferred. One of these aromatic vinyl monomers may be used alone, or two or more thereof may be used in combination.

The polymerizable monomer for forming the glassy polymer may contain a polyfunctional monomer having two or more polymerizable functional groups in the molecule. The polyfunctional monomer having two or more polymerizable functional groups in the molecule may be contained in an amount of 0 to 10 wt %, in an amount of 0 to 8 wt %, or in an amount of 0 to 5 wt % based on 100 wt % of the polymerizable monomer for forming the glassy polymer.

Specific examples of the polyfunctional monomer having two or more polymerizable functional groups in the molecule include such polyfunctional monomers as previously mentioned.

The polymerizable monomer for forming the glassy polymer may contain another polymerizable monomer copolymerizable with the alkyl (meth)acrylate and the polyfunctional monomer having two or more polymerizable functional groups in the molecule. The other polymerizable monomer may be contained in an amount of 0 to 50 wt % or in an amount of 0 to 40 wt % based on 100 wt % of the polymerizable monomer for forming the glassy polymer.

Examples of the other polymerizable monomer include: vinyl cyanides such as acrylonitrile and methacrylonitrile; vinylidene cyanides; alkyl (meth)acrylates other than those previously mentioned; and other polymerizable monomers such as urethane acrylate and urethane methacrylate. The other polymerizable monomer may be a monomer having a functional group such as an epoxy group, a carboxyl group, a hydroxy group, or an amino group. Examples of the monomer having an epoxy group include glycidyl methacrylate. Examples of the monomer having a carboxyl group include methacrylic acid, acrylic acid, maleic acid, and itaconic acid. Examples of the monomer having a hydroxy group include 2-hydroxy methacrylate and 2-hydroxy acrylate. Examples of the monomer having an amino group include diethylaminoethyl methacrylate and diethylaminoethyl acrylate. One of the monomers as mentioned above may be used alone, or two or more thereof may be used in combination.

Like the polymerizable monomer used to form the rubbery polymer layer, the polymerizable monomer for forming the glassy polymer may be used in combination with a small amount of known chain transfer agent.

The method employed to produce the core-shell elastic material may be any suitable method capable of producing core-shell particles.

An example of the method is one in which: the polymerizable monomer for forming the rubbery polymer constituting the core layer is subjected to suspension polymerization or emulsion polymerization to produce a suspension or an emulsion containing rubbery polymer particles; and the polymerizable monomer for forming the glassy polymer constituting the shell layer is added to the suspension or the emulsion, in which radical polymerization of the polymerizable monomer is carried out to obtain a core-shell elastic material having a multi-layered structure composed of the rubbery polymer particle whose surface is covered by the glassy polymer. The polymerizable monomer for forming the rubbery polymer or the polymerizable monomer for forming the glassy polymer may be polymerized in a single stage or in two or more stages with varying monomer proportions.

Examples of preferred structures of the core-shell elastic material include: (a) a structure which has a soft, rubbery core layer and a rigid, glassy shell layer and in which the core layer has a crosslinked elastic (meth)acrylic polymer layer; and (b) a structure in which the rubbery core layer has a multi-layered structure having one or more inner glassy layers and which has a glassy shell layer on the exterior of the core layer. The various physical properties of the glutarimide resin can be freely controlled by appropriately selecting the types of the monomers for forming the layers.

Specific examples of more preferred structures of the core-shell elastic material include: (A) a structure in which the shell layer of the core-shell elastic material may be made of a non-crosslinked methacrylic resin containing 3 wt % or more, 10 wt % or more, or 15 wt % or more, of an alkyl acrylate; (B) a structure in which the shell layer of the core-shell elastic material is composed of two or more layers differing in alkyl acrylate content and may be made of a non-crosslinked methacrylic resin containing 10 wt % or more, or 15 wt % or more, of an alkyl acrylate in total; (C) a structure in which the core layer of the core-shell elastic material has a multi-layered structure composed of a glassy polymer layer formed by polymerizing a mixture containing an alkyl methacrylate, a polyfunctional monomer, an alkyl mercaptan, and optionally another monomer, and a rubbery polymer layer formed by polymerizing a mixture containing an alkyl acrylate, a polyfunctional monomer, an alkyl mercaptan, and optionally another monomer in the presence of the glassy polymer layer; and (D) a structure in which the core layer of the core-shell elastic material has a multi-layered structure composed of a glassy polymer layer formed by polymerization using an organic peroxide as a redox polymerization initiator, and a rubbery polymer layer formed by polymerization using a peracid (such as a salt of persulfuric acid or perphosphoric acid) as a thermally-decomposable initiator in the presence of the glassy polymer layer. One of these preferred design factors concerning the structure of the core-shell elastic material may be employed, or two or more of the design factors may be employed in combination. When the core-shell elastic material has a preferred structure as described above, the core-shell elastic material is dispersed well in the glutarimide resin according to the present disclosure, so that when a film is formed, the film can be a high-quality film that has few defects arising from poor dispersion or aggregation of the core-shell elastic material, that is excellent in strength, toughness, heat resistance, transparency, and appearance, and that is resistant to blushing caused by a temperature change or a stress.

When the core-shell elastic material is produced by a process such as emulsion polymerization or suspension polymerization, a known polymerization initiator can be used. Examples of particularly preferred polymerization initiators include: persulfuric acid salts such as potassium persulfate, ammonium persulfate, and ammonium persulfate; perphosphoric acid salts such as sodium perphosphate; organic azo compounds such as 2,2-azobisisobutyronitrile; hydroperoxide compounds such as cumene hydroperoxide, tert-butyl hydroperoxide, and 1,1-dimethyl-2-hydroxyethyl hydroperoxide; peresters such as tert-butyl isopropyloxycarbonate and tert-butyl peroxybutyrate; and organic peroxide compounds such as benzoyl peroxide, dibutyl peroxide, and lauryl peroxide. Any of these polymerization initiators may be used as a thermally-decomposable polymerization initiator or may be used as a redox polymerization initiator in the presence of a catalyst such as iron(II) sulfate and a water-soluble reductant such as ascorbic acid or sodium formaldehyde sulfoxylate. The polymerization initiator used may be selected as appropriate depending on factors such as the types and proportions of the monomers to be polymerized, the layer structure, and the polymerization temperature conditions.

In the case of producing the core-shell elastic material by emulsion polymerization, the production can be accomplished by a common emulsion polymerization process using a known emulsifier. Examples of the known emulsifier include: anionic surfactants such as sodium alkyl sulfonates, sodium alkylbenzene sulfonates, sodium dioctyl sulfosuccinate, sodium lauryl sulfate, fatty acid sodium salts, and phosphate salts such as sodium polyoxyethylene lauryl ether phosphate; and non-ionic surfactants such as reaction products of alkylphenols or aliphatic alcohols with propylene oxide or ethylene oxide. One of these surfactants may be used alone, or two or more thereof may be used in combination. If necessary, a cationic surfactant such as an alkylamine salt may be used. Among the surfactants as mentioned above, a phosphate salt (salt of an alkali metal or an alkaline earth metal) such as sodium polyoxyethylene lauryl ether phosphate is particularly may be used for the polymerization in terms of improving the thermal stability of the resulting core-shell elastic material. The core-shell elastic material latex resulting from emulsion polymerization is spray-dried to obtain the core-shell elastic material in the form of a powder. Alternatively, as is commonly known, a coagulant such as an electrolyte or organic solvent may be added to the latex to coagulate the polymer component, and processes such as heating, washing, and aqueous phase separation may be performed as appropriate to dry the polymer component and obtain the core-shell elastic material in the form of a solid mass or powder. The coagulant used may be a known coagulant such as a water-soluble electrolyte or an organic solvent. In terms of improving the thermal stability of the resulting copolymer in a molding process and in terms of productivity, it is preferable to use a magnesium salt such as magnesium chloride or magnesium sulfate or a calcium salt such as calcium acetate or calcium chloride.

In the case where the glutarimide resin composition according to the present disclosure contains the core-shell elastic material, the core-shell elastic material may be contained in an amount of 1 to 40 parts by weight, in an amount of 2 to 35 parts by weight, or in an amount of 3 to 25 parts by weight per 100 parts by weight of the glutarimide resin. If the amount of the core-shell elastic material is less than 1 part by weight, the enhancement of the mechanical strength of the glutarimide resin could be insufficient. If the amount of the core-shell elastic material is more than 40 parts by weight, the heat resistance of the glutarimide resin could be reduced.

As to the preferred particle size of the core-shell elastic material, the particle size of the soft core layer may be from 1 to 500 nm, from 10 to 400 nm, from 50 to 300 nm, or from 70 to 300 nm. If the particle size of the core layer of the core-shell elastic material is less than 1 nm, the enhancement of the mechanical strength of the glutarimide resin could be insufficient. If the particle size of the core layer is more than 500 nm, the heat resistance or transparency of the glutarimide resin could be reduced.

The particle size of the core layer of the core-shell elastic material can be determined as follows. The core-shell crosslinked elastic material and SUMIPEX EX are blended in a weight ratio of 50:50 to give a compound, which is formed into a film. The film is subjected to ultramicrotomy combined with RuO₄ staining to prepare a test specimen, which is observed with a transmission electron microscope (JEM-1200 EX manufactured by JEOL Ltd.) at an accelerating voltage of 80 kV. One hundred rubber particles are randomly selected from the microscopic image, and the average of the particle sizes of the selected particles is determined as the particle size of the core layer.

(Film Containing Glutarimide Resin Composition)

The glutarimide resin composition can be formed into a film containing the glutarimide resin composition by a known molding method.

The haze value of the film containing the glutarimide resin composition may be 2.0% or less or 1.0% or less. The transmittance of the film may be 85% or more or 90% or more.

It is preferable that both the haze value and the transmittance be in the mentioned ranges, because in this case the range of applications of the film extends.

The film is not particularly limited as to the optical anisotropy. In some cases, it is preferable that not only the optical anisotropy in the in-plane directions (length and width directions) but also the optical anisotropy in the thickness direction be small. That is, in some cases, it is preferable that both the in-plane retardation and the out-of-plane retardation be small.

Specifically, the in-plane retardation at a wavelength of 590 nm may be 10 nm or less, 5 nm or less, or 1 nm or less.

The out-of-plane retardation at a wavelength of 590 nm may be 40 nm or less, 15 nm or less, or 3 nm or less.

The in-plane retardation (Re) and the out-of-plane retardation (Rth) can be calculated by the following equations, respectively.

Re=(nx−ny)×d

Rth=|(nx+ny)/2−nz|×d

In the equations, nx denotes a refractive index in an X-axis direction in which the in-plane refractive index has a maximum, ny denotes a refractive index in a Y-axis direction perpendicular to the X-axis direction, and nz denotes a refractive index in a Z-axis direction which is the thickness direction of the film. The letter d denotes the thickness of the film, and 11 denotes an absolute value.

The film obtained from the glutarimide resin composition according to the present disclosure contains little amount of foreign substances. The number of foreign substances may be 50/m² or less, 40/m² or less, or 30/m² or less. The number of foreign substances is determined as follows. The film stretched is cut to prepare a film piece with an area of 1 m², the film piece is observed by means such as a microscope to count the number of foreign substances having a size of 20 μm or more, and the total counted number is determined as the number of foreign substances.

The film containing the glutarimide resin composition according to the present disclosure can be used as a substrate of an electronic material. Specifically, the film can be used as any of various products such as substrates for antennas, substrates for flexible displays, substrates for foldable displays, substrates for rollable displays, substrates for touch panels, substrates for transparent displays, substrates for spatial displays, substrates for holograms, substrates for signage, head-up display-related members (viewpoint adjustment films, image adjustment films, image projection screens, retroreflection films, lens sheets, and dust covers), brightness enhancement films, cover glass substitutes, glass substrate substitutes, reflective films, anti-reflective films, anti-glare films, base materials of single-sided or double-sided tapes or adhesive films for electronic devices, optical waveguides of AR glasses, substrates for light control devices, substrates for light shielding devices, high-frequency circuit board films, transparent flexible printed boards, films for battery separators, back covers of smartphones, mold-release films, and detector substrates of X-ray machines.

The film is suitable also for use in other products, including: products in the imaging industry, such as imaging lenses, viewfinders, filters, prisms, and Fresnel lenses for cameras, VTRs, and projectors; products in the lens industry, such as pick-up lenses for optical disc drives such as CD, DVD, and MD players; products in the optical recording industry, such as optical recording media for optical disc drives such as CD, DVD, and MD players; products in the information equipment industry, such as light guide panels for liquid crystal displays, films for liquid crystal displays (e.g., polarizer protective films and retardation films), and surface protective films; products in the optical communication industry, such as optical fibers, optical switches, and optical connectors; products in the vehicle industry, such as headlight lenses, tail lamp lenses, inner lenses, instrument covers, and sunroofs of automobiles; products in the medical equipment industry, such as eyeglasses, contact lenses, lenses for endoscopes, and medical tools that need to be sterilized; products in the building and construction industry, such as transparent panels for roads, lenses for double-glazed glass, lighting windows, carports, lenses for lighting devices, covers for lighting devices, and siding for buildings; and microwavable containers (dishes).

As described above, the film according to the present disclosure is excellent in optical properties such as optical homogeneity and transparency. By virtue of these optical properties, the film is particularly suitable for use as any of known optical products, including liquid crystal display-related members such as optically isotropic films, polarizer protective films, and transparent electrically-conductive films.

The film according to the present disclosure can be attached to a polarizer, and the polarizer with the film attached thereto can be used as a polarizing plate. That is, the film can be used as a polarizer protective film of a polarizing plate. The polarizer is not limited to a particular type, and any conventionally known polarizer can be used. A specific example is a polarizer obtained by incorporating iodine in a stretched polyvinyl alcohol material.

(Method for Producing Film)

The following will describe one embodiment of the method for producing the film according to the present disclosure. One or more embodiments of the present invention are not limited to the embodiment described below. That is, it is possible to use any conventionally known method capable of molding the glutarimide resin described above to produce a film.

Specific examples of the method include injection molding, melt extrusion molding, blown film molding, blow molding, and compression molding. The film can be produced also by solution casting or spin coating in which the glutarimide resin is dissolved in a solvent capable of dissolving the glutarimide resin and then the solution is formed into a film shape.

Among the above methods, melt extrusion molding which does not require any solvent may be used. The use of melt extrusion molding can reduce the production cost and the solvent-induced impact on the global environment or working environment.

Hereinafter, a method for producing a film by molding the above-described glutarimide resin by melt extrusion molding will be described in detail as one embodiment of the method for producing the film according to the present disclosure. In the following description, a film obtained by melt extrusion molding may be referred to as a “melt-extruded film” to distinguish it from films obtained by other methods such as solution casting.

In the case where the glutarimide resin is formed into a film by melt extrusion molding, first, the glutarimide resin is fed to an extruder, in which the glutarimide resin is heated and melted.

Preferably, the glutarimide resin is preliminarily dried before being fed to the extruder. The preliminary drying can prevent bubble formation in the resin extruded from the extruder.

The method for the preliminary drying is not limited to a particular technique. For example, the raw material (i.e., the glutarimide resin) may be formed into pellets or the like and then dried by means such as a hot air dryer or a vacuum dryer.

Next, the glutarimide resin heated and melted in the extruder is fed to a T-die through a gear pump or a filter. The use of a gear pump can improve the constancy of the amount of the resin extruded and thus reduce the thickness variation in the length direction of the resulting film. The use of a filter can remove foreign substances from the glutarimide resin, resulting in a film free of defects and having a good appearance.

Next, the glutarimide resin fed to the T-die is extruded as a sheet-shaped molten resin from the T-die. The sheet-shaped molten resin is sandwiched and cooled between two cooling rolls to form the resin into a film.

The film formation temperature is not limited to a particular range. In the case of film formation at a high temperature, the resin viscosity can be reduced, but there is a risk of decomposition of the resin. The film formation temperature may be 300° C. or lower or 280° C. or lower.

Preferably, one of the two cooling rolls that sandwich the sheet-shaped molten resin is a rigid metal roll having a smooth surface, and the other cooling roll is a flexible roll including an elastic outer cylinder made of metal that has a smooth surface and that is elastically deformable.

As a result of the film formation performed by sandwiching and cooling the sheet-shaped molten resin between the rigid metal roll and the flexible roll including an elastic outer cylinder made of metal, small surface irregularities, die lines, and the like are corrected, and thus a film having a smooth surface and having a thickness variation of 5 μm or less can be obtained. The term “cooling roll” as used herein is intended to include a “touch roll” and a “cooling roll”.

Even in the case of using the rigid metal roll and the flexible roll, if the film formed is extremely thin, the outer surfaces of the two cooling rolls come into contact with each other, and this contact could cause scratches on the outer surfaces of the cooling rolls or breakage of the cooling rolls since the outer surfaces are made of metal.

Thus, in the case where the film formation is performed by sandwiching the sheet-shaped molten resin between the two cooling rolls as described above, the sheet-shaped molten resin is first formed into a relatively thick film web by sandwiching and cooling the sheet-shaped molten resin between the two cooling rolls. After that, the film web may be stretched uniaxially or biaxially to produce a film with a given thickness.

To be specific, in the case where a film with a thickness of 40 μm is to be produced, the sheet-shaped molten resin may be sandwiched and cooled between the two cooling rolls to obtain a film web with a thickness of 150 μm. After that, the film web may be stretched longitudinally and transversely to produce the film with a thickness of 40 μm.

As described above, in the case where the film is a stretched film, the glutarimide resin is first formed into an unstretched film web, and then the film web is stretched uniaxially or biaxially. In this manner, the stretched film can be produced.

Biaxial stretching is preferred in order to enhance the folding endurance of the film according to the present disclosure in both the length direction (MD direction) and the width direction (TD direction) of the film.

A film into which the glutarimide resin has been formed and which has not yet been stretched, i.e., an unstretched film, is referred to herein as a “film web” for convenience of illustration.

In the case where a film web is stretched, the formation of the film web may be immediately followed by the stretching of the film web without interruption. Alternatively, after the formation of the film web, the film web may be stored or transferred and then stretched.

In the case where the formation of the film web is immediately followed by the stretching of the film web, the film web only has to retain a film shape to a degree sufficient for stretching and need not be in a complete film form if the workpiece takes the form of the film web only for a very short time (for a moment in some cases) during the film production process. The film web need not have the same properties as the film to be produced as an end product.

The method for stretching the film web is not limited to a particular technique, and any conventionally known stretching method may be employed. Specifically, for example, transverse stretching using a tenter, longitudinal stretching using a roll, or sequential biaxial stretching combining the transverse stretching and the longitudinal stretching sequentially can be employed. Simultaneous biaxial stretching consisting of performing longitudinal stretching and transverse stretching simultaneously may also be employed. Alternatively, longitudinal stretching using a roll may be performed first, and then transverse stretching using a tenter may be performed.

In the stretching of the film web, it is preferable to preheat the film web to a temperature 0.5 to 5° C. above, preferably 1 to 3° C. above, the stretching temperature, then cool the film web to the stretching temperature, and stretch the film web.

Preheating the film web in the above temperature range makes it possible to accurately maintain the thickness of the film web in the width direction and also to prevent a reduction in the thickness accuracy of the stretched film or the occurrence of thickness variation in the stretched film. Additionally, the film web is prevented from sticking to the roll or sagging under its own weight.

If the preheating temperature of the film web is extremely high, sticking of the film web to the roll and sagging of the film web under its own weight tend to arise. If the difference between the preheating temperature and the stretching temperature of the film web is small, the thickness accuracy of the unstretched film web tends to be difficult to maintain, or the stretched film tends to suffer a large thickness variation or a reduction in thickness accuracy.

When the glutarimide resin is formed into a film web and the film web is stretched, it is difficult to improve the thickness accuracy by making use of the phenomenon of necking. Thus, the control of the preheating temperature is effective to maintain or improve the thickness accuracy of the resulting film.

The stretching temperature at which the film web is stretched is not limited to a particular range, and may be changed depending on the properties such as mechanical strength, surface texture, and thickness accuracy required of the stretched film to be produced. In general, denoting by Tg the glass transition temperature of the film web (glutarimide resin composition) as determined by DSC analysis, the stretching temperature may be in the temperature range of (Tg−30° C.) to (Tg+30° C.), in the temperature range of (Tg−20° C.) to (Tg+30° C.), in the temperature range of (Tg−10° C.) to (Tg+30° C.), in the temperature range of (Tg) to (Tg+30° C.), or in the temperature range of (Tg+10° C.) to (Tg+30° C.). That is, denoting the glass transition temperature of the glutarimide resin composition by Tg, the stretching temperature for biaxial stretching of an optical film may be in the temperature range of Tg−30° C. to Tg+30° C.

When the stretching temperature is in the temperature range as mentioned above, the thickness variation of the resulting stretched film can be reduced, and the mechanical properties such as elongation, tear propagation strength, and MIT folding endurance of the stretched film can be improved. Additionally, troubles such as sticking of the film to the roll can be prevented.

If the stretching temperature is above the temperature range as mentioned above, the thickness variation of the resulting stretched film tends to increase, or improvements in mechanical properties such as elongation, tear propagation strength, and crease-flex resistance tend to be insufficient. Furthermore, troubles such as sticking of the film to the roll tend to arise.

If the stretching temperature is below the temperature range as mentioned above, the internal haze of the resulting stretched film tends to increase. In extreme cases, tearing or breakage of the film tend to arise during the stretching step.

In the case where the film web is stretched, the stretching factor is not limited to a particular range and may be chosen depending on the properties such as mechanical strength, surface texture, and thickness accuracy of the stretched film to be produced. In general, the stretching factor may be selected in the range of 1.1 to 3 times, selected in the range of 1.3 to 2.5 times, or selected in the range of 1.5 to 2.3 times although the preferred stretching factor depends on the stretching temperature.

When the stretching factor is in the range as mentioned above, the film mechanical properties such as elongation, tear propagation strength, and crease-flex resistance can be significantly improved. Thus, a stretched film having a thickness variation of 5 μm or less and an internal haze of 1.0% or less can be produced.

In the case where the glutarimide resin according to the present disclosure contains a crosslinked elastic material, the film has high mechanical strength. Thus, in this case, the film is suitable for use as any of an unstretched film, a uniaxially stretched film, or a biaxially stretched film.

(Substrate Containing Glutarimide Resin Composition)

A film formed from the glutarimide resin composition according to the present disclosure can be used as a substrate. Being excellent in dielectric properties, heat resistance, weathering resistance, and transparency, the substrate can be used, for example, for an antenna, a windowpane of a vehicle, a windowpane of a building, a display of an industrial machine, or a display of a household electronic device or display device.

As to the dielectric properties, for example, the value of the dielectric loss tangent Df, as measured at a frequency of 3 GHz, may be 0.010 or less or 0.007 or less. When the value of Df is in this range, the energy loss is low. The value of the dielectric constant Dk may be 3.2 or less or 3.0 or less.

If the substrate expands or contracts in response to a temperature rise, an antenna part made of a conductor also undergoes a size change along with the expansion or contraction of the substrate. Since the antenna size is unambiguously defined based on the wavelength corresponding to the resonant frequency, it is not preferable for the antenna size to change due to causes such as a temperature rise. Thus, the linear expansion coefficient of the substrate may be 100 ppm or less or 80 ppm or less.

### EXAMPLES

Hereinafter, one or more embodiments of the present invention will be specifically described using examples. The technical scope of one or more embodiments of the present invention is not limited by the examples given below.

(1) M1 and M2

An amount of 30 mg of the resin was dissolved in 0.75 ml of deuterated DMSO (0.75 ml of deuterated acetone in Example 2), and the dissolved resin was subjected to ¹H-NMR spectroscopy using Avance NEO 700 (700 MHz), a 1H-NMR spectrometer manufactured by BRUKER. An area A of a peak observed at around 3.5 to 3.8 ppm and attributed to the O—CH₃ protons of methyl methacrylate was divided by 3 to give a value A′. An area B of a peak observed at around 3.0 to 3.3 ppm and attributed to the N—CH₃ protons of the formula (2) was divided by 3 to give a value B′. An area C of a peak observed at around 10.4 to 10.9 ppm and attributed to the N—H proton of the formula (1) was calculated. An area D of a peak observed at around 12.3 to 12.9 ppm and attributed to the COOH proton was calculated. The M1 and M2 were determined from the values A′, B′, C, and D by the following equations.

M1=C/(A′+B′+C+D)×100

M2=B′/(A′+B′+C+D)×100

(2) Glass Transition Temperature (Tg)

An amount of 10 mg of the glutarimide resin was analyzed using a differential scanning calorimeter (DSC; DSC-50 manufactured by Shimadzu Corporation) in a nitrogen atmosphere at a temperature rise rate of 20° C./min, and the glass transition temperature was determined by a midpoint method.

(3) TGA Measurement (Measurement of 5% Weight Loss-on-Heating Temperature)

An amount of 15 mg of the glutarimide resin was analyzed using a thermogravimetric analyzer (TGA; STA 7200 manufactured by Hitachi High-Tech Science Corporation) in a nitrogen atmosphere with a temperature rise from room temperature at a rate of 10° C./min, and the temperature at which the weight loss on heating (wt %) of the glutarimide resin reached 5% was determined.

(4) Total Light Transmittance

The glutarimide resin was dissolved in methylene chloride (resin concentration=25 wt %) and the solution was applied to a PET film, on which the solution was dried to make a film. The film was cut to prepare a test specimen with a size of 50 mm×50 mm. The total light transmittance of the test specimen was measured using a turbidimeter, 300A manufactured by Nippon Denshoku Industries Co., Ltd. The measurement was performed at a temperature of 23° C.±2° C. and a humidity of 50%±5% according to JIS K 7105.

(5) Haze

The haze of the test specimen as obtained in item (4) above was measured using a turbidimeter, 300A manufactured by Nippon Denshoku Industries Co., Ltd. The measurement was performed at a temperature of 23° C.±2° C. and a humidity of 50%±5% according to JIS K 7136.

(6) In-Plane Retardation Re and Orientation Birefringence

The film as made in item (4) above was cut to prepare a sample with a width of 50 mm and a length of 150 mm. The sample was stretched by a factor of 100% at a temperature 5° C. above the glass transition temperature, and thus a stretched film was produced. The central portion of the two-fold uniaxially stretched film in the TD direction was cut to prepare a test specimen with a size of 40 mm×40 mm. The in-plane retardation Re of the test specimen was measured using an automatic birefringence measuring device (KOBRA-WR manufactured by Oji Scientific Instruments Co., Ltd.) The measurement was performed at a temperature of 23° C.±2° C., a humidity of 50%±5%, a wavelength of 590 nm, and an incident angle of 0°.

The in-plane retardation Re was divided by the thickness of the test specimen, and the quotient was used as the value of the orientation birefringence. The thickness of the test specimen was measured using a Digimatic indicator manufactured by Mitutoyo Corporation at a temperature of 23° C.±2° C. and a humidity of 60%±5%.

(7) Acid Value

An amount of 0.3 g of the glutarimide resin was dissolved in 37.5 mL of methylene chloride, and 37.5 mL of methanol was added to the solution. Subsequently, 5 mL of a 0.1 mmol % aqueous solution of sodium hydroxide and several drops of an ethanol solution of phenolphthalein were added. This was followed by back titration using 0.1 mmol % hydrochloric acid, and the acid value was determined from the amount of hydrochloric acid needed for neutralization.

(8) Quantification of Acrylic Ester Units

A raw material resin for producing the glutarimide resin was analyzed using a pyrolysis-gas chromatography-mass spectrometer manufactured by Shimadzu Corporation. The sample pyrolysis temperature was set to 590° C. and held for 5 sec. Acrylic ester units were quantified from the ratio between the area of the peak attributed to methyl methacrylate and the area of the peak attributed to the acrylic ester units.

(9) Weight-Average Molecular Weight (Mw)

The weight-average molecular weight (Mw) of the resin was calculated by a standard polystyrene-equivalent method using gel permeation chromatography (GPC). The GPC column used was one packed with a crosslinked polystyrene gel (product name: Shodex GPC K-806M, manufactured by Showa Denko K.K.), and the GPC solvent used was chloroform. The sample solution was prepared by dissolving 5 mg of the resin powder in 2 ml of chloroform, and the column temperature was set to 40° C.

### Example 1

A glutarimide resin was produced using a 40-mm-dia. full-intermeshing corotating twin-screw extrusion reactor. The extruder used was an intermeshing corotating twin-screw extruder which had a diameter of 40 mm and in which the L/D (the ratio of the length L of the extruder to the diameter D of the extruder) was 90. A gravimetric feeder (CE-T-2E manufactured by KUBOTA Corporation) was used to introduce a raw material resin into the raw material inlet of the extruder. The reduced pressure at the vent in the extruder was −0.10 MPa. The resin (strand) discharged from the extruder was cooled in a cooling water bath, and the cooled resin (strand) was cut into pellets by a pelletizer. A resin pressure meter was disposed at the outlet of the extruder to check the pressure inside the extruder or detect unstable extrusion.

In the production of the glutarimide resin, a poly(methyl methacrylate) resin (Mw: 10.5×10⁴, acrylic ester unit content: less than 0.1 wt %) was used as the raw material resin, and 28 wt % ammonia water was used as the imidization agent. In this production process, the temperature of the hottest region of the extruder was 280° C., the screw rotational speed was 300 rpm, the raw material resin feed rate was 10 kg/hour, and the amount of ammonia water was 4.0 parts by weight (corresponding to 1.12 parts by weight of ammonia) per 100 parts by weight of the raw material resin.

For the glutarimide resin, the glass transition temperature was 134.5° C., the M1 was 4.3 mol %, the M2 was 3.3 mol %, and the acid value was 0.9245 mmol/g. The orientation birefringence was 2.3×10⁻⁴. The content of the repeating units represented by the formula (3) was 87.4 mol %. The evaluation results are listed in Table 1.

### Comparative Example 1

A glutarimide resin was obtained in the same manner as in Example 1, except that 1.8 parts by weight of methylamine gas was added instead of ammonia water. The evaluation results are listed in Table 1.

### Comparative Example 2

The poly(methyl methacrylate) resin used as the raw material resin was evaluated in the same manner as the glutarimide resins. The evaluation results are listed in Table 1.

TABLE 1

| | | | M1 + | | Acid | | | 5% weight | | | |
|---|---|---|---|---|---|---|---|---|---|---|---|
| | M1 | M2 | M2 | | value | | | loss-on-heating | Orientation | | Trans- |
| | (mol | (mol | (mol | M1/ | (mmol/ | Molecular | Tg | temperature | [symbol] | Haze | mittance |
| | %) | %) | %) | M2 | g) | weight | (° C.) | (° C.) | (×10 [symbol] ) | (%) | (%) |
| Example 1 | 4.3 | 3.3 | 7.6 | 1.3 | 0.92 | 90 [symbol] 3 | 1 [symbol] | 371 | 0. [symbol] | 0. [symbol] 1 | 92.3 |
| Com- | 0 | [symbol] .7 | [symbol] .7 | 0.0 | 0.44 | 10 [symbol] 43 | 1 [symbol] | 3 [symbol] | 0.00 [symbol] | — | — |
| parative | | | | | | | | | | | |
| Example 1 | | | | | | | | | | | |
| Com- | 0 | 0 | 0 | — | — | 10 [symbol] 43 | 124 | 322 | −0.5 | — | — |
| parative | | | | | | | | | | | |
| Example 2 | | | | | | | | | | | |

[symbol]

indicates data missing or illegible when filed

Table 1 reveals that the orientation birefringence was satisfactorily small for the glutarimide resin of Example 1 which contained both the repeating units represented by the formula (1) and the repeating units represented by the formula (2), and that the glutarimide resin of Example 1 had a higher glass transition temperature and better heat resistance than the glutarimide resin of Comparative Example 1 which did not contain the repeating units represented by the formula (1) and than the poly(methyl methacrylate) resin of Comparative Example 2.

### Examples 2 to 4

Glutarimide resins were obtained in the same manner as in Example 1, except that instead of ammonia water, liquid ammonia was added in the amounts shown in Table 2. The evaluation results are listed in Table 2.

TABLE 2

| | Amount of | | | M1 + | | Acid | | 5% weight | |
|---|---|---|---|---|---|---|---|---|---|
| | ammonia | M1 | M2 | M2 | | value | | loss-on-heating | Orientation |
| | (parts by | (mol | (mol | (mol | M1/ | (mmol/ | Tg | temperature | [symbol] |
| | weight) | %) | %) | %) | M2 | g) | (° C.) | (° C.) | (×10 [symbol] ) |
| Example 2 | 0.96 | 1.5 | 1.7 | 3.2 | 0.9 | 0.27 | 129.8 | 354 | 0.15 |
| Example 3 | 1.8 | 5.0 | 5.2 | 10.2 | 1.0 | 0.36 | 13 [symbol] .3 | 361 | 1.00 |
| Example 4 | 2.24 | 8.6 | 6.4 | 15.0 | 1.3 | 0.43 | 137.7 | 362 | 1.74 |

[symbol]

indicates data missing or illegible when filed

Table 2 reveals that the orientation birefringence was satisfactorily small for the glutarimide resins of Examples 2 to 4 which contained both the repeating units represented by the formula (1) and the repeating units represented by the formula (2) and in which the contents of these repeating units satisfied the inequality (a), and that the glutarimide resins of Examples 2 to 4 had a higher glass transition temperature and better heat resistance than the resins of Comparative Examples 1 and 2.

In Comparative Example 1, 1.8 parts by weight of methylamine was used, while the amount of ammonia used in Example 2 was only about half the amount of methylamine used in Comparative Example 1. Nonetheless, the glutarimide resin of Example 2 had a higher glass transition temperature and better heat resistance than the glutarimide resin of Comparative Example 1. This is presumably because whereas the glutarimide resin of Comparative Example 1 contained only the repeating units represented by the formula (2), the glutarimide resin of Example 2 contained the repeating units represented by the formula (1) in addition to the repeating units represented by the formula (2).

In Example 2, the amount of the imidization agent used was smaller than in Comparative Example 1. This is advantageous in that the retention time in the extruder can be shortened, the discharge rate can be easily increased, and the amount of gas emission in the imidization step can be reduced.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A glutarimide resin comprising:
repeating units represented by the following formula (1): 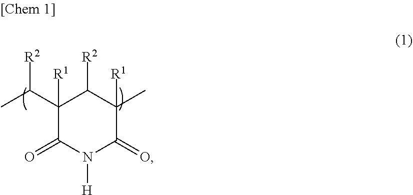
wherein R¹ and R² are each independently hydrogen or an alkyl group having 1 to 8 carbon atoms;
repeating units represented by the following formula (2): 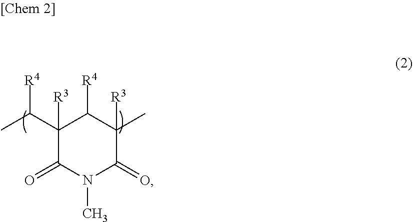
wherein R³ and R⁴ are each independently hydrogen or an alkyl group having 1 to 8 carbon atoms; and
repeating units represented by the following formula (3): 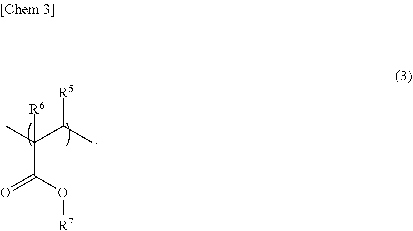
wherein R⁵ and R⁶ are each independently hydrogen or an alkyl group having 1 to 8 carbon atoms, and IC is an alkyl group having 1 to 18 carbon atoms, a cycloalkyl group having 3 to 12 carbon atoms, or a substituent containing an aromatic ring having 5 to 15 carbon atoms,
wherein the glutarimide resin satisfies the following inequality (a):
3≤M1+M2≤20 (a),
wherein M1 is a content mol % of the repeating units represented by the formula (1) in the glutarimide resin, M2 is a content mol % of the repeating units represented by the formula (2) in the glutarimide resin, M1>0, and M2>0.

2. The glutarimide resin according to claim 1, wherein a glass transition temperature of the glutarimide resin is 120° C. or higher.

3. The glutarimide resin according to claim 1, wherein a 5% weight loss temperature in TGA measurement of the glutarimide resin is 350° C. or higher.

4. The glutarimide resin according to claim 1, wherein an orientation birefringence of the glutarimide resin is from −0.01×10⁻³ to 2.0×10⁻³.

5. A glutarimide resin composition comprising the glutarimide resin according to claim 1.

6. An optical film comprising the glutarimide resin composition according to claim 5.

7. The optical film according to claim 6, wherein
an in-plane retardation Re of the optical film at a wavelength of 590 nm is 10 nm or less, and
an absolute value of an out-of-plane retardation Rth of the optical film at a wavelength of 590 nm is 40 nm or less.

8. A polarizer protective film comprising the optical film according to claim 6.

9. A substrate comprising the glutarimide resin composition according to claim 5.

10. A method for producing a glutarimide resin, the method comprising reacting a raw material resin with ammonia, wherein the raw material resin has a content of acrylic ester monomer units of less than 1 wt % and comprises repeating units represented by the following formula (3): 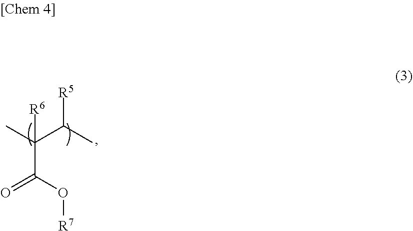
wherein R⁵ and R⁶ are each independently hydrogen or an alkyl group having 1 to 8 carbon atoms, and R⁷ is an alkyl group having 1 to 18 carbon atoms, a cycloalkyl group having 3 to 12 carbon atoms, or a substituent containing an aromatic ring having 5 to 15 carbon atoms.
